(19) United States
(12) Patent Application Publication
(10) Pub. No.: US 2019/0236956 A1
(43) Pub. Date: Aug. 1, 2019

(54) WORK MANAGEMENT DEVICE, WORK MANAGEMENT METHOD, PROGRAM, AND CARGO-HANDLING MACHINE

(71) Applicant: NEC CORPORATION, Tokyo (JP)

(72) Inventors: Jun UCHIMURA, Tokyo (JP); Hideaki TAKAHASHI, Tokyo (JP)

(73) Assignee: NEC CORPORATION, Tokyo (JP)

(21) Appl. No.: 16/335,105

(22) PCT Filed: Sep. 4, 2017
(86) PCT No.: PCT/JP2017/031763

§ 371 Date: Mar. 20, 2019

(30) Foreign Application Priority Data
Sep. 27, 2016 (JP) 2016-188195

(51) Int. Cl. G08G 1/16; G06K 7/10; B66F 9/075; G01S 11/06

(52) U.S. Cl. CPC G08G 1/165; G01S 11/06; B66F 9/0755; G06K 7/10366

(57) ABSTRACT

A work management device includes a reception strength acquisition unit and a warning output unit. The reception strength acquisition unit acquires a reception strength of a transportation target identification signal transmitted from a first signal transmission device attached to a transportation target when the transportation target identification signal is received by a reading device attached to a cargo-handling machine. The warning output unit outputs warning information associated with work of the transportation target on the basis of a result of a comparison between the reception strength and a predetermined first threshold value used in outputting a proximity warning.

### TECHNICAL FIELD

The present invention relates to a work management device, a work management method, a program, and a cargo-handling machine.

### BACKGROUND ART

In the logistics industry, radio-frequency identification (RFID) tags are attached to cargoes, and the identification numbers of cargoes are read from the RFID tags to perform the distribution management of cargoes. Techniques for managing cargoes using RFID tags are disclosed in Patent Literature 1 and Non-Patent Literature 1. In addition, a relevant technique is disclosed in Patent Literature 2.

### CITATION LIST

### Patent Literature

[Patent Literature 1]
Japanese Unexamined Patent Application, First Publication No. 2008-19046
[Patent Literature 2]
Japanese Unexamined Patent Application, First Publication No. 2014-237357

### Non-Patent Literature

[Non-Patent Literature 1]
Part 2. Experiments/practical cases, Utilization of IC tags in logistics work, “Nikkei BP Mook, All of wireless IC tag”, Nikkei BP Inc., Apr. 20, 2004, p. 70-71

### SUMMARY OF INVENTION

### Technical Problem

Patent Literature 1 stated above discloses a technique in which, when a forklift puts its fork-shaped arms into a container, identification (ID) information of an RFID tag attached to the container is read. In addition, Non-Patent Literature 1 also discloses a similar technique.

As is the case with a forklift, a top lifter is present as a cargo-handling machine that transports a container. In the operation of such a cargo-handling machine, a driver needs to operate it while taking care that a transportation target such as a container and a cargo-handling machine do not collide with each other. However, since a blind spot is generated in the operation of a cargo-handling machine that transports a large-size transportation target such as a container, the transportation target and a predetermined portion of a cargo-grasping mechanism such as the fork of the cargo-handling machine may collide with each other. In addition, accuracy of work is required in the above-mentioned cargo-handling machine.

An object of this invention is to provide a work management device, a work management method, a program, and a cargo-handling machine which make it possible to solve the above-mentioned problem.

### Solution to Problem

According to a first aspect of the present invention, a work management device is provided, including: a reception strength acquisition unit that acquires a reception strength of a transportation target identification signal transmitted from a first signal transmission device attached to a transportation target when the transportation target identification signal is received by a reading device attached to a cargo-handling machine; and a warning output unit that outputs warning information associated with work of the transportation target on the basis of a result of a comparison between the reception strength and a predetermined first threshold value used in outputting a proximity warning.

According to a second aspect of the present invention, a work management method is provided, including: acquiring a reception strength of a transportation target identification signal transmitted from a first signal transmission device attached to a transportation target when the transportation target identification signal is received by a reading device attached to a cargo-handling machine; and outputting warning information associated with work of the transportation target on the basis of a result of a comparison between the reception strength and a predetermined first threshold value used in outputting a proximity warning.

According to a third aspect of the present invention, a program is provided causing a computer to function as: reception strength acquisition means for acquiring a reception strength of a transportation target identification signal transmitted from a first signal transmission device attached to a transportation target when the transportation target identification signal is received by a reading device attached to a cargo-handling machine; and warning output means for outputting warning information associated with work of the transportation target on the basis of a result of a comparison between the reception strength and a predetermined first threshold value used in outputting a proximity warning.

According to a fourth aspect of the present invention, a cargo-handling machine is provided including the above-described work management device.

### Advantageous Effects of Invention

According to the present invention, it is possible to improve the accuracy of transportation work for a transportation target such as a container by operating a cargo-handling machine such as a forklift or a top lifter.

### BRIEF DESCRIPTION OF DRAWINGS

FIG. 1 is a diagram illustrating a relationship between a forklift and a container according to an embodiment of the present invention.

FIG. 2 is a first diagram illustrating an example of a carry-in source or a carry-out destination according to the embodiment of the present invention.

FIG. 3 is a second diagram illustrating an example of a carry-in source or a carry-out destination according to the embodiment of the present invention.

FIG. 4 is a third diagram illustrating an example of a carry-in source or a carry-out destination according to the embodiment of the present invention.

FIG. 5 is a diagram illustrating a hardware configuration of a work management device according to the embodiment of the present invention.

FIG. 6 is a functional block diagram of the work management device according to the embodiment of the present invention.

FIG. 7 is a diagram illustrating a first operation example of a forklift according to the embodiment of the present invention.

FIG. 8 is a diagram illustrating a second operation example of the forklift according to the embodiment of the present invention.

FIG. 9 is a first diagram illustrating a process flow of the work management device according to the embodiment of the present invention.

FIG. 10 is a second diagram illustrating a process flow of the work management device according to the embodiment of the present invention.

FIG. 11 is a diagram illustrating a minimum configuration of the work management device according to an embodiment of the present invention.

### DESCRIPTION OF EMBODIMENT

Hereinafter, a work management device, a work management method, a program and a cargo-handling machine according to an embodiment of the present invention will be described with reference to the accompanying drawings.

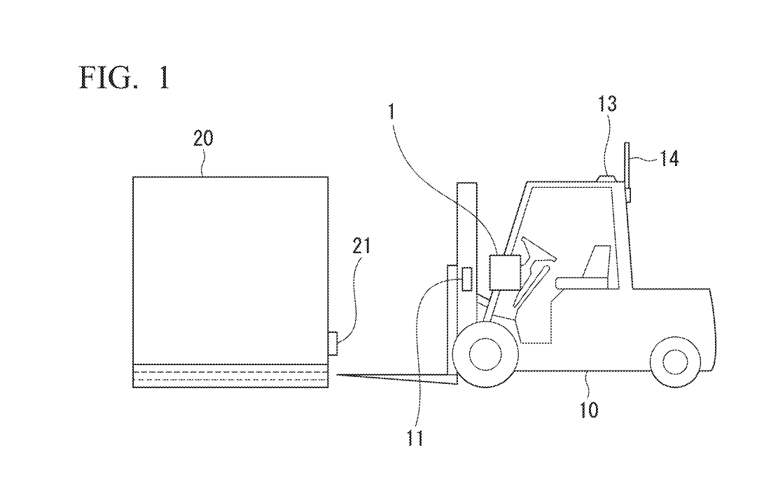

FIG. 1 is a diagram illustrating a relationship between a forklift 10 and a container 20 according to the present embodiment.

In FIG. 1, the forklift 10 is an example of a cargo-handling machine. In addition, the container 20 is an example of a transportation target. The forklift 10 includes a work management device 1, an antenna 11 (reading device), a satellite positioning antenna 13, a communication antenna 14 and the like. Since the detailed configuration of the forklift 10 is well known, the description thereof will be omitted. An integrated circuit (IC) tag 21 (signal transmission device) is attached to the container 20. The container 20 is provided with an insertion hole for inserting the fork (cargo-grasping mechanism) of the forklift 10. The IC tag 21 is attached to, for example, the vicinity of this insertion hole. In a case where the forklift 10 comes too close to the container 20, a member or the like rising substantially vertically from the vicinity of the fork root (base) of the forklift 10 may collide with the surface of the container 20 which is provided with the insertion hole. The IC tag 21 is provided on a surface or the like that collides with a cargo-handling machine such as the forklift 10. In addition, the antenna 11 may also be provided in the vicinity of a position on a cargo-handling machine such as the forklift 10 at which a transportation target such as the container 20 and the cargo-handling machine collide with each other. That is, the IC tag 21 attached to the container 20 and the antenna 11 attached to the forklift 10 are attached to positions that approach each other when the forklift 10 loads the container 20.

The satellite positioning antenna 13 is an antenna that receives signals from artificial satellites. The work management device 1 acquires information included in signals received from artificial satellites by the satellite positioning antenna 13. The work management device 1 detects the position of the forklift 10 on the basis of the information included in the signals.

The work management device 1 transmits and receives signals through the communication antenna 14 during communication with another device. The communication antenna 14 is connected to the work management device 1 by the communication cable.

The work management device 1 manages work of a transportation target such as the container 20. The work management device 1 acquires the reception strength of a signal when the signal transmitted from the IC tag 21 is received by the antenna 11. The antenna 11 may measure reception strength, or the work management device 1 may measure reception strength on the basis of information corresponding to the signal acquired from the antenna 11. The work management device 1 outputs warning information associated with work of the container 20 or the like which is a transportation target on the basis of a result of a comparison between the reception strength of the received signal and a predetermined threshold value used in outputting a proximity warning. The warning information is, for example, information for warning that the container 20 and the forklift 10 collide with each other. The work management device 1 warns a driver of the forklift 10 of work to transport the container 20 which is not in conformity with a work instruction or work in a carry-in source or a carry-out destination which is not in conformity with a work instruction as a work error. The work instruction indicates an instruction for transporting the container 20 which is a transportation target from a designated carry-in source to a designated carry-out destination.

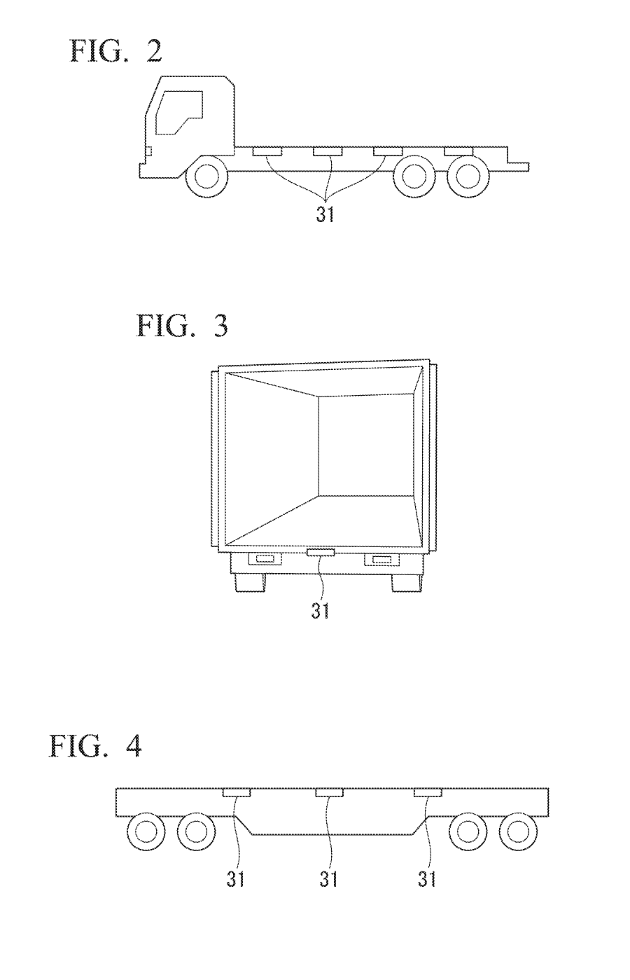

FIG. 2 is a first diagram illustrating an example of a carry-in source or a carry-out destination.

FIG. 2 shows a first truck as an example of a carry-in source or a carry-out destination of a transportation target, or a collision target. A plurality of placement position tags 31 (signal transmission devices) that transmit a placement position ID are attached to the first truck. The cargo bed of the first truck is not provided with a box-shaped cover. In this case, the forklift 10 can load the container 20 from the side of the cargo bed onto the cargo bed. The forklift 10 can perform work to load the container 20 from the side of the cargo bed onto the fork and carry the loaded container out to another transportation destination. In a case where the forklift 10 performs work to unload the container 20 onto the first truck or carries the container out from the first truck, there is the possibility of the cargo bed or the like of the first truck and the vicinity of the fork root of the forklift 10 colliding with each other due to an error of a driver's driving operation or the like. In order to prevent such a collision or prevent the placement position of the container 20 from being different from a placement position according to a work instruction, the placement position tags 31 are provided on the edge of the cargo bed of the first truck in its longitudinal direction.

FIG. 3 is a second diagram illustrating an example of a carry-in source or a carry-out destination.

FIG. 3 shows a second truck as an example of a carry-in source or a carry-out destination of a transportation target or a collision target. The placement position tag 31 that transmits a placement position ID is also attached to the second truck. The second truck is provided with a box-shaped cover on its cargo bed. In this case, in a state where the rear door of the box-shaped cover provided on the cargo bed is open, the forklift 10 can load the container 20 from the rear of the truck onto the cargo bed in accordance with a driver's operation. The forklift 10 can perform work to load the container 20 from the rear of the truck onto the fork and carry the loaded container out to another transportation destination. In work for the forklift 10 to unload the container 20 onto the second truck or work to carry the container out from the second truck, there is the possibility of the rear portion of the second truck and the vicinity of the fork root of the forklift 10 colliding with each other due to an error of a driver's driving operation or the like. In order to prevent such a collision, the placement position tag 31 is provided on the edge of the cargo bed located on the rear of the cargo bed of the second truck.

FIG. 4 is a third diagram illustrating an example of a carry-in source or a carry-out destination.

FIG. 4 shows a freight car as an example of a carry-in source or a carry-out destination of a transportation target or a collision target. The placement position tags 31 that transmit a placement position ID are also attached to the freight car. In this case, the forklift 10 can load the container 20 from the side of the freight car onto the cargo bed. The forklift 10 can perform work to load the container 20 from the side of the freight car onto the fork and carry the loaded container out to another transportation destination. In work for the forklift 10 to unload the container 20 onto the freight car or work to carry the container out from the freight car, there is the possibility of the freight car and the vicinity of the fork root of the forklift 10 colliding with each other due to an error of a driver's driving operation or the like. In order to prevent such a collision or prevent the placement position of the container 20 from being different from a placement position according to a work instruction, the placement position tags 31 are provided on the edge of the freight car in its longitudinal direction.

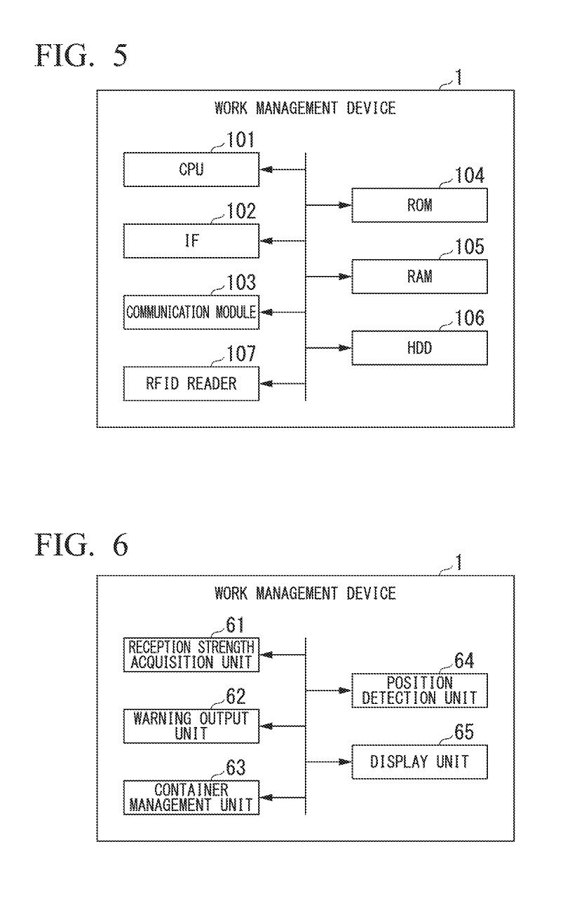

FIG. 5 is a diagram illustrating a hardware configuration of the work management device 1.

As shown in FIG. 5, the work management device 1 includes components such as a central processing unit (CPU) 101, an interface (IF) 102, a communication module 103, a read-only memory (ROM) 104, a random-access memory (RAM) 105, a hard disk drive (HDD) 106 and a radio-frequency identification (RFID) reader 107 (reading device). The communication module 103 transmits and receives signals through the communication antenna 14. The RFID reader 107 performs a signal-reading process based on the reception of a signal in the antenna 11. The IF 102 is connected to an input and output device such as, for example, a touch panel display provided on the work management device 1, and inputs and outputs information to and from the input and output device.

FIG. 6 is a functional block diagram of the work management device 1.

The work management device 1 implements functions of a reception strength acquisition unit 61, a warning output unit 62, a container management unit 63, a position detection unit 64 and a display unit 65 by the CPU 101 executing programs stored in advance.

The reception strength acquisition unit 61 acquires the reception strength of a signal when a signal (transportation target identification signal) transmitted from the IC tag 21 or a signal (placement position identification signal) transmitted from the placement position tag 31 is received by the antenna 11.

The warning output unit 62 outputs warning information associated with work of a transportation target on the basis of a result of a comparison between the reception strength acquired by the reception strength acquisition unit 61 and a threshold value.

The container management unit 63 manages cargo-handling work of the container 20 on the basis of work instruction information received from a work instruction center device. The work instruction information indicates a work instruction for a transportation target. The work instruction information includes a container ID for identifying the container 20 which is a transportation target, a placement position ID for identifying a carry-in source and a placement position ID for identifying a carry-out destination.

The position detection unit 64 detects the position of the forklift 10.

The display unit 65 outputs various types of information to a monitor connected to the work management device 1.

The warning output unit 62 of the work management device 1 of the present embodiment reads a container ID included in the work instruction information. In a case where the read container ID and a container ID indicated by a signal received from the IC tag 21 are identical to each other and where the reception strength of the signal is equal to or greater than a threshold value, the warning output unit 62 outputs warning information. In this case, the warning information is information for warning that the container 20 and the forklift 10 are close to each other.

In a case where the container ID included in the work instruction information and a container ID indicated by a signal having a highest reception strength among a plurality of received signals are identical to each other and where the reception strength of the signal is equal to or greater than a threshold value, the warning output unit 62 output warning information. In this case, the warning information is information for warning that the container 20 and the forklift 10 are close to each other.

In a case where the container ID included in the work instruction information and a container ID indicated by the received signal are not identical to each other, the warning output unit 62 outputs warning information. In this case, the warning information is information for warning of a work error of transporting a container 20 (transportation target) having a container ID different from the container ID of the container 20 (transportation target) included in the work instruction information.

In a case where the container ID included in the work instruction information and a container ID indicated by a signal having a highest reception strength among a plurality of received signals are not identical to each other, the warning output unit 62 outputs warning information associated with work of a transportation target. In this case, the warning information is information for warning of a work error of transporting a container 20 (transportation target) having a container ID different from the container ID of the container 20 (transportation target) included in the work instruction information.

In a case where a placement position ID of a carry-out destination included in the work instruction information and a placement position ID indicated by the received signal are identical to each other, the warning output unit 62 outputs warning information on the basis of a result of a comparison between the reception strength of the signal and a predetermined threshold value used in outputting a proximity warning. In this case, the warning information is information for warning that the container 20 and the forklift 10 are close to each other.

In a case where a placement position ID of a carry-in source included in the work instruction information and a placement position ID indicated by the received signal are identical to each other, the warning output unit 62 may output warning information on the basis of a result of a comparison between the reception strength of the signal and a predetermined threshold value used in outputting a proximity warning.

In a case where the placement position ID of the carry-out destination included in the work instruction information and a placement position ID indicated by a signal having the second highest reception strength among a plurality of received signals are identical to each other, the warning output unit 62 outputs warning information on the basis of a result of a comparison between the reception strength of the signal having the second highest reception strength and a threshold value used in outputting a proximity warning. In this case, the warning information is information for warning that the container 20 and the forklift 10 are close to each other.

In a case where the placement position ID of the carry-in source included in the work instruction information and a placement position ID indicated by a signal having the second highest reception strength among a plurality of received signals are identical to each other, the warning output unit 62 may output warning information on the basis of a result of a comparison between the reception strength of the signal having the second highest reception strength and a threshold value used in outputting a proximity warning.

In a case where the placement position ID of the carry-out destination included in the work instruction information and a placement position ID indicated by the received signal are not identical to each other, the warning output unit 62 outputs warning information. In this case, the warning information is information for warning of a work error of transporting a container 20 to a carry-out destination having a placement position ID different from the placement position ID of the carry-out destination included in the work instruction information.

In a case where the placement position ID of the carry-in source included in the work instruction information and a placement position ID indicated by the received signal are not identical to each other, the warning output unit 62 may output warning information.

In a case where the placement position ID of the carry-out destination included in the work instruction information and a placement position ID indicated by a signal having a second highest reception strength among a plurality of received signals are not identical to each other, the warning output unit 62 output warning information. In this case, the warning information is information for warning of a work error of transporting a container 20 to a carry-out destination having a placement position ID different from the placement position ID of the carry-out destination included in the work instruction information.

In a case where the placement position ID of the carry-in source included in the work instruction information and a placement position ID indicated by a signal having a second highest reception strength among a plurality of received signals are not identical to each other, the warning output unit 62 may output warning information.

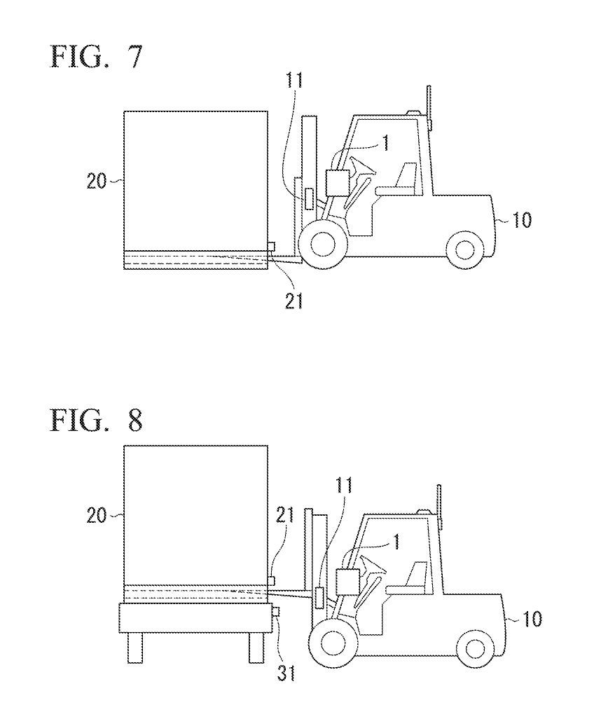

FIG. 7 is a diagram illustrating a first operation example of the forklift 10.

FIG. 7 shows an operation example in a case where the forklift 10 loads the container 20 placed on a plot such as a container yard which is a carry-in source, in accordance with a driver's operation. In this case, the IC tag 21 and the antenna 11 are close to each other. In a case where the IC tag 21 and the antenna 11 are close to each other, the reception strength acquisition unit 61 detects that a signal transmitted from the IC tag 21 has been received at a reception strength equal to or greater than a first threshold value. Then, the warning output unit 62 outputs first warning information indicating a risk of collision. In a case where a signal has been received at a reception strength equal to or greater than the first threshold value, the warning output unit 62 outputs the first warning information one time. Thereby, a driver operates the forklift 10 so that the first warning information continues not to be output.

The reception strength acquisition unit 61 may receive signals transmitted from a plurality of IC tags 21. For example, in a case where containers 20 are disposed side by side, the reception strength acquisition unit 61 receives a signal from each of the IC tags 21 provided to each of these containers 20. The warning output unit 62 specifies a container ID, indicated by a signal having a highest reception strength among a plurality of received signals, as a container ID included in a signal transmitted from an IC tag 21 attached to a container 20 which is attempted to be transported by the forklift 10. In a case where it is detected that a signal including the container ID has been received at a reception strength equal to or greater than the first threshold value, the warning output unit 62 outputs the first warning information indicating a risk of collision.

The reception strength acquisition unit 61 may detect that a signal transmitted from the IC tag 21 has been received at a reception strength equal to or greater than a second threshold value smaller than the first threshold value. In this case, the warning output unit 62 may output second warning information to inform a driver to be aware that the forklift 10 is close to the container 20. In a case where a signal has been received at a reception strength equal to or greater than the second threshold value, the warning output unit 62 outputs the second warning information one time. Thereby, driver operates the forklift 10 so that the second warning information continues not to be output.

The container management unit 63 acquires work instruction information transmitted from a work instruction center device located at a remote place. The container management unit 63 outputs a container ID included in the work instruction information to the warning output unit 62. In a case where a container ID is included in each of a plurality of received signals, the warning output unit 62 selects a container ID included in a signal having a highest reception strength. The warning output unit 62 determines the selected container ID to be a comparison target with respect to the container ID included in the work instruction information. The warning output unit 62 determines whether the container ID included in the work instruction information and the selected container ID are identical to each other. In a case where the container ID included in the work instruction information and the selected container ID are not identical to each other, the warning output unit 62 outputs warning information indicating that the container 20 which is a transportation target is different from the container 20 indicated by the work instruction information.

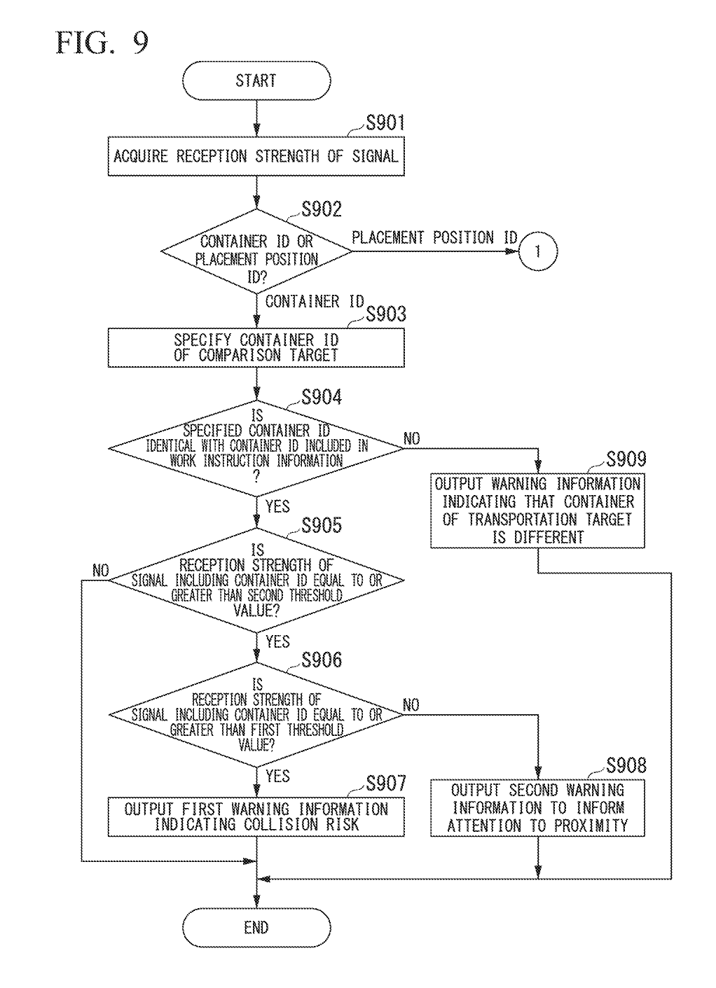

FIG. 8 is a diagram illustrating a second operation example of the forklift 10.

FIG. 8 shows an operation example in a case where the forklift 10 unloads the container 20 onto a carry-out destination in accordance with a driver's operation or a case where the container is loaded on the forklift 10 in a carry-in source. In this case, the placement position tag 31 and the antenna 11 are close to each other. In a case where the placement position tag 31 and the antenna 11 are close to each other, the reception strength acquisition unit 61 detects that a signal transmitted from the placement position tag 31 has been received at a reception strength equal to or greater than a third threshold value. Then, the warning output unit 62 outputs third warning information indicating a risk of collision. The third threshold value may be a value indicating the same reception strength as that of the first threshold value. In a case where a signal has been received at a reception strength equal to or greater than the third threshold value, the warning output unit 62 outputs the third warning information indicating a risk of collision one time. Thereby, a driver operates the forklift 10 so that the third warning information continues not to be output.

The reception strength acquisition unit 61 may receive signals transmitted from a plurality of placement position tags 31. For example, in a case where the plurality of placement position tags 31 are attached side by side as shown in FIG. 2, the reception strength acquisition unit 61 receives a signal from each of the plurality of placement position tags 31. The warning output unit 62 selects a placement position ID indicated by a signal having a second highest reception strength among a plurality of signals received by the antenna 11. The warning output unit 62 specifies the selected placement position ID as a placement position ID included in a signal transmitted from a placement position tag 31 attached to a position at which the container 20 is disposed or a position at which the container 20 is attempted to be disposed. In a case where it is detected that a signal including the specified placement position ID has been received at a reception strength equal to or greater than the third threshold value, the warning output unit 62 outputs the third warning information indicating a risk of collision. A signal having a highest reception strength among a plurality of signals received by the antenna 11 is a signal which is received from an IC tag 21 of the container 20 held by the forklift 10. Therefore, in a case where the forklift 10 has come close to a carry-in source or a carry-out destination such as a truck in a state of holding the container 20, a signal from a placement position tag 31 attached to the carry-in source or the carry-out destination becomes a signal having a second highest reception strength. In a case where a plurality of placement position tags 31 are attached to a truck or the like which is a carry-in source or a carry-out destination, a signal from a placement position tag 31 closest to the forklift 10 becomes a signal having a second highest reception strength. A signal from an IC tag 21 capable of being attached to the container 20 held by the forklift 10 is a signal having a highest reception strength. Signals having third and subsequent reception strengths among a plurality of signals received by the antenna 11 are signals transmitted from placement position tags 31 attached to positions different from placement positions to which the forklift 10 is close.

The reception strength acquisition unit 61 may detect that a signal transmitted from the placement position tag 31 has been received at a reception strength equal to or greater than a fourth threshold value smaller than the third threshold value. In this case, the warning output unit 62 may output fourth warning information to inform a driver to be aware that the forklift 10 is close to a carry-in source or a carry-out destination such as a truck or a freight car having the container 20 disposed therein. In a case where a signal has been received at a reception strength equal to or less than the third threshold value and equal to or greater than the fourth threshold value, the warning output unit 62 outputs the fourth warning information one time. Thereby, a driver operates the forklift 10 so that the fourth warning information continues not to be output.

The container management unit 63 acquires work instruction information transmitted from a work instruction center device located at a remote place. The container management unit 63 outputs a placement position ID included in the work instruction information to the warning output unit 62. In a case where a plurality of signals have been received, the warning output unit 62 selects a placement position ID included in a signal having a second highest reception strength. The warning output unit 62 determines the selected placement position ID to be a comparison target with respect to a placement position ID of a carry-in source or a carry-out destination included in the work instruction information. The warning output unit 62 determines whether the placement position ID included in the work instruction information and the selected placement position ID are identical to each other. In a case where the placement position ID included in the work instruction information and the selected placement position ID are not identical to each other, the warning output unit 62 outputs warning information for giving notice of a work error.

FIG. 9 is a first diagram illustrating a process flow of the work management device 1.

The reception strength acquisition unit 61 acquires the reception strength of a signal received by the antenna 11 (step S901). The reception strength acquisition unit 61 outputs the acquired reception strength to the warning output unit 62. In a case where the antenna 11 receives a plurality of signals, the warning output unit 62 determines whether an ID included in each signal is a container ID or a placement position ID (step S902). In a case where the container ID is included, the warning output unit 62 advances the process to step S903. In addition, in a case where the placement position ID is included, the warning output unit 62 also advances the process to step S1001.

In a case where the container ID is included, the warning output unit 62 specifies a container ID included in a signal having a highest reception strength as a comparison target (step S903). In a case where the antenna 11 receives only one signal, the warning output unit 62 specifies a container ID included in the signal as a comparison target. The warning output unit 62 determines whether a container ID included in the work instruction information and the specified container ID are identical to each other (step S904). In a case where the two containers ID are identical to each other, the warning output unit 62 compares the reception strength of a signal including the specified container ID with the second threshold value, and determines whether the reception strength is equal to or greater than the second threshold value (step S905). In a case where the reception strength is equal to or greater than the second threshold value, the warning output unit 62 compares the reception strength of a signal including the specified container ID with the first threshold value (step S906). In a case where the reception strength is equal to or greater than the first threshold value, the warning output unit 62 outputs the first warning information indicating a risk of collision (step S907). The first threshold value is greater than the second threshold value.

In a case where the reception strength is not equal to or greater than the first threshold value in the process of step S906, the warning output unit 62 outputs the second warning information to inform a driver to be aware that the forklift 10 is close to the container 20 (step S908). In a case where it is determined in step S904 that the container ID included in the work instruction information and the container ID specified as a comparison target are not identical to each other, the warning output unit 62 outputs warning information indicating that the container 20 which is a transportation target is different from the container 20 indicated by the work instruction information (step S909).

FIG. 10 is a diagram illustrating a process flow of the work management device 1.

The warning output unit 62 specifies a placement position ID included in a signal having a second highest reception strength as a placement position ID of a comparison target (step S1001). In addition, in a case where an container ID are not detected in IDs included in signals received by the antenna 11, the warning output unit 62 may omit the process of step S1001. That is, the warning output unit 62 may specify a placement position ID included in a signal having a highest reception strength as a comparison target. The warning output unit 62 determines whether the placement position ID included in the work instruction information and the specified placement position ID are identical to each other (step S1002). In a case where the two placement positions ID are identical to each other, the warning output unit 62 compares the reception strength of a signal including the specified placement position ID with the fourth threshold value, and determines whether the reception strength is equal to or greater than the fourth threshold value (step S1003). In a case where the reception strength is equal to or greater than the fourth threshold value, the warning output unit 62 compares the reception strength of a signal including the specified placement position ID with the third threshold value (step S1004). In a case where the reception strength is equal to or greater than the third threshold value, the warning output unit 62 outputs the third warning information indicating a risk of collision (step S1005). The third threshold value is greater than the fourth threshold value.

In a case where the reception strength is not equal to or greater than the third threshold value in the process of step S1004, the warning output unit 62 outputs the fourth warning information to inform a driver to be aware that the forklift 10 is close to a carry-in source or a carry-out destination (step S1006). In a case where it is determined in step S1002 that the placement position ID included in the work instruction information and the placement position ID specified as a comparison target are not identical to each other, the warning output unit 62 outputs warning information for warning of a work error of a carry-in source or a carry-out destination of a placement position ID different from the placement position ID of the carry-in source or the carry-out destination included in the work instruction information (step S1007).

The first to fourth threshold values described above are values which are set by a user in accordance with the position of the antenna 11 and are record in a storage unit of the work management device 1. These threshold values are values appropriate to output each piece of warning information. Each threshold value is determined on the basis of values obtained by previously performing measurement, experiments or the like. For example, the first threshold value is determined so that warning information is output, on the basis of a reception strength when a transportation target is located at a position where there is a high possibility of colliding with a cargo-handling machine. The second threshold value is determined so that warning information is output, on the basis of a reception strength when a transportation target is located at a position where attention is required in a case of being close to a cargo-handling machine. The third threshold value is determined so that warning information is output, on the basis of a reception strength when a member at the placement position of a transportation target of a carry-in source or a carry-out destination is located at a position where there is a high possibility of colliding with a cargo-handling machine. The fourth threshold value is determined so that warning information is output, on the basis of a reception strength when a member at the placement position of a transportation target of a carry-in source or a carry-out destination is located at a position where attention is required in a case of being close to a cargo-handling machine.

The process of the work management device 1 described above makes it possible to improve the accuracy of transportation work for a transportation target such as the container 20 by operating the forklift 10 or a cargo-handling machine such as a top lifter. That is, the work management device 1 can give a driver a warning or attention so as to prevent the forklift 10 and the container 20, which is a transportation target, from colliding with each other. The work management device 1 can notify a driver of the transportation of a different container 20 or work in a carry-in source or a carry-out destination which is not in conformity with a work instruction.

In the above-described process, the warning output unit 62 may output each piece of warning information as characters, sounds, light, vibration or the like. For example, in a case where the warning information is output as characters, the warning output unit 62 outputs the warning information to the display unit 65, and the display unit 65 displays the warning information on a monitor or the like. In a case where the warning information is output as sounds, the warning output unit 62 outputs sounds or voices from a speaker. In a case where the warning information is represented by light, the warning output unit 62 turns on a light. In a case where the warning information is output as vibration, the warning output unit 62 may drive a mechanism that vibrates the handle or the like of a cargo-handling machine. As output aspects of the warning information, any aspect may be used.

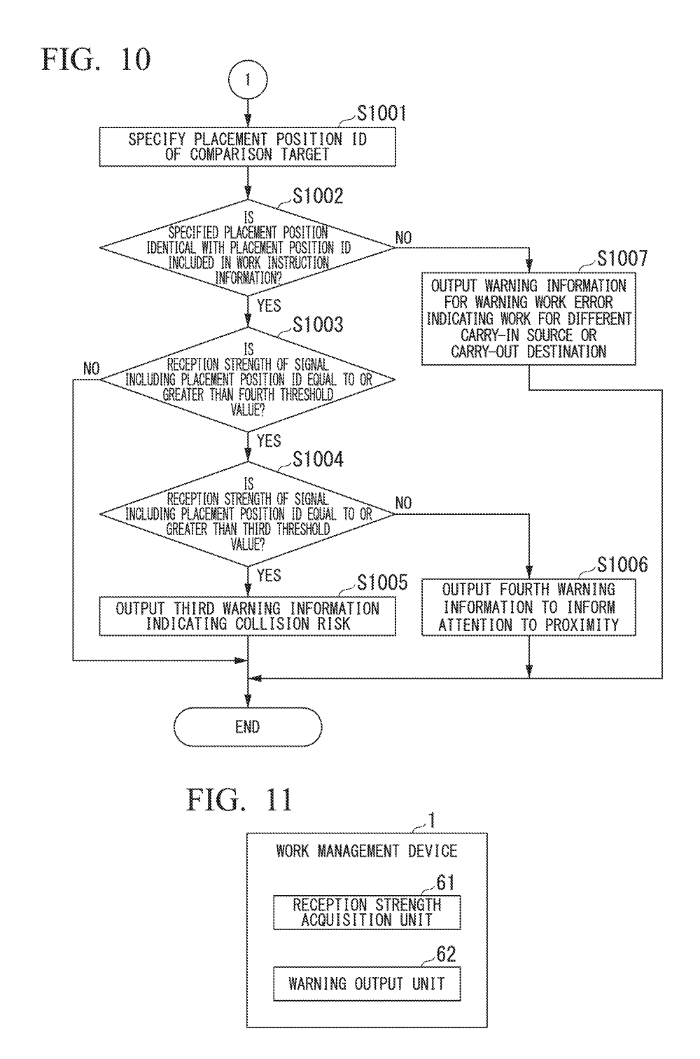

FIG. 11 is a diagram illustrating a minimum configuration of the work management device 1.

As shown in FIG. 11, the work management device 1 includes at least the reception strength acquisition unit 61 and the warning output unit 62.

The above-described work management device includes a computer system therein. The procedure of each process is stored in a computer-readable recording medium in the form of a program, and the above process is performed by a computer reading out and executing such a program. The term “computer-readable recording medium” as used herein refers to a magnetic disc, a magneto-optic disc, a CD-ROM, a DVD-ROM, a semiconductor memory or the like. In addition, such a computer program may be delivered to a computer through a communication line, and the computer having received this delivery may execute the program.

In addition, the above-mentioned program may realize some of the above-mentioned functions. Further, the above-mentioned program may be a so-called difference file (difference program) capable of realizing the above-mentioned functions by a combination with a program which is already recorded in a computer.

Some or the entirety of the embodiment described above may also include the following additions, but there is no limitation thereto.

(Supplementary Note 1)

A work management device, including:

a reception strength acquisition unit that acquires a reception strength of a transportation target identification signal transmitted from a first signal transmission device attached to a transportation target when the transportation target identification signal is received by a reading device attached to a cargo-handling machine; and

a warning output unit that outputs warning information associated with work of the transportation target on the basis of a result of a comparison between the reception strength and a predetermined first threshold value used in outputting a proximity warning.

(Supplementary Note 2)

The work management device according to Supplementary Note 1,

wherein the warning output unit reads an identifier of the transportation target included in work instruction information indicating a work instruction for the transportation target, and outputs the warning information in a case where the read identifier and an identifier indicated by the received transportation target identification signal are identical to each other.

(Supplementary Note 3)

The work management device according to Supplementary Note 2,

wherein the warning output unit outputs the warning information in a case where the read identifier and an identifier indicated by a transportation target identification signal having a highest reception strength among a plurality of the received transportation target identification signals are identical to each other.

(Supplementary Note 4)

The work management device according to Supplementary Note 1,

wherein the warning output unit reads an identifier of the transportation target included in work instruction information indicating a work instruction for the transportation target, and outputs the warning information in a case where the read identifier and an identifier indicated by the received transportation target identification signal are not identical to each other.

(Supplementary Note 5)

The work management device according to Supplementary Note 4,

wherein the warning output unit outputs the warning information in a case where the read identifier and an identifier indicated by a transportation target identification signal having a highest reception strength among a plurality of the received transportation target identification signals are not identical to each other.

(Supplementary Note 6)

The work management device according to Supplementary Note 1,

wherein the reception strength acquisition unit acquires a reception strength of a placement position identification signal transmitted from a second signal transmission device attached to a carry-in source and a carry-out destination of the transportation target when the placement position identification signal is received by the reading device, and

the warning output unit reads an identifier of the carry-in source or the carry-out destination included in work instruction information indicating a work instruction for the transportation target, and outputs the warning information on the basis of a result of a comparison between a reception strength of the received placement position identification signal and a predetermined third threshold value used in outputting a proximity warning in a case where the read identifier and an identifier indicated by the received placement position identification signal are identical to each other.

(Supplementary Note 7)

The work management device according to Supplementary Note 6,

wherein, in a case where the read identifier and an identifier indicated by a signal having a second highest reception strength among a plurality of acquired reception strengths are identical to each other, the warning output unit outputs the warning information on the basis of a result of a comparison between the reception strength of the signal having a second highest reception strength and a predetermined third threshold value used in outputting a proximity warning.

(Supplementary Note 8)

The work management device according to Supplementary Note 6,

wherein the warning output unit outputs the warning information in a case where the read identifier and the identifier indicated by the received placement position identification signal are not identical to each other.

(Supplementary Note 9)

The work management device according to Supplementary Note 7,

wherein the warning output unit outputs the warning information in a case where the read identifier and the identifier indicated by the signal having a second highest reception strength are not identical to each other.

(Supplementary Note 10)

The work management device according to any one of Supplementary Notes 1, 2, 3, 6, and 7,

wherein the warning information associated with work is information for warning that the transportation target and the cargo-handling machine are close to each other.

(Supplementary Note 11)

The work management device according to Supplementary Note 4 or 5,

wherein the warning information associated with work is information for warning of a work error of transporting a transportation target having an identifier different from the identifier of the transportation target included in the work instruction information.

(Supplementary Note 12)

The work management device according to Supplementary Note 8 or 9,

wherein the warning information associated with work is information for warning of a work error of a carry-in source or a carry-out destination having an identifier different from the identifier of the carry-in source or the carry-out destination included in the work instruction information.

(Supplementary Note 13)

A work management method, including:

acquiring a reception strength of a transportation target identification signal transmitted from a first signal transmission device attached to a transportation target when the transportation target identification signal is received by a reading device attached to a cargo-handling machine; and outputting warning information associated with work of the transportation target on the basis of a result of a comparison between the reception strength and a predetermined first threshold value used in outputting a proximity warning.

(Supplementary Note 14)

A program causing a computer to function as:

reception strength acquisition means for acquiring a reception strength of a transportation target identification signal transmitted from a first signal transmission device attached to a transportation target when the transportation target identification signal is received by a reading device attached to a cargo-handling machine; and

warning output means for outputting warning information associated with work of the transportation target on the basis of a result of a comparison between the reception strength and a predetermined first threshold value used in outputting a proximity warning.

(Supplementary Note 15)

A cargo-handling machine including a work management device according to any one of Supplementary Notes 1 to 12.

Priority is claimed on Japanese Patent Application No. 2016-188195, filed Sep. 27, 2016, the content of which is incorporated herein by reference.

### INDUSTRIAL APPLICABILITY

The present invention can be applied to an application which is required to improve the accuracy of transportation work for a transportation target such as a container by operating a cargo-handling machine such as a forklift or a top lifter.

### REFERENCE SIGNS LIST

1 Work management device
10 Forklift
11 Antenna
13 Satellite positioning antenna
14 Communication antenna
20 Container
21 IC tag
31 Placement position tag
61 Reception strength acquisition unit
62 Warning output unit
63 Container management unit
64 Position detection unit
65 Display unit

1. A work management device comprising:
a reception strength acquisition unit that acquires a reception strength of a transportation target identification signal transmitted from a first signal transmission device attached to a transportation target when the transportation target identification signal is received by a reading device attached to a cargo-handling machine; and
a warning output unit that outputs warning information associated with work of the transportation target on a basis of a result of a comparison between the reception strength and a predetermined first threshold value used in outputting a proximity warning.

2. The work management device according to claim 1,
wherein the warning output unit reads an identifier of the transportation target included in work instruction information indicating a work instruction for the transportation target, and outputs the warning information in a case where the read identifier and an identifier indicated by the received transportation target identification signal are identical to each other.

3. The work management device according to claim 2,
wherein the reading device receives a plurality of transportation target identification signals, and
wherein the warning output unit outputs the warning information in a case where the read identifier is identical to an identifier indicated by a transportation target identification signal having a highest reception strength among the plurality of the received transportation target identification signals.

4. The work management device according to claim 1,
wherein the warning output unit reads an identifier of the transportation target included in work instruction information indicating a work instruction for the transportation target, and outputs the warning information in a case where the read identifier and an identifier indicated by the received transportation target identification signal are not identical to each other.

5. The work management device according to claim 4,
wherein the reading device receives a plurality of transportation target identification signals, and
wherein the warning output unit outputs the warning information in a case where the read identifier is identical to an identifier indicated by a transportation target identification signal having a highest reception strength among the plurality of the received transportation target identification signals.

6. The work management device according to claim 1,
wherein the reception strength acquisition unit acquires a reception strength of a placement position identification signal transmitted from a second signal transmission device attached to a carry-in source and a carry-out destination of the transportation target when the placement position identification signal is received by the reading device, and
the warning output unit reads an identifier of the carry-in source or the carry-out destination included in work instruction information indicating a work instruction for the transportation target, and outputs the warning information on a basis of a result of a comparison between a reception strength of the received placement position identification signal and a predetermined third threshold value used in outputting a proximity warning in a case where the read identifier and an identifier indicated by the received placement position identification signal are identical to each other.

7. The work management device according to claim 6,
wherein, in a case where the read identifier and an identifier indicated by a signal having a second highest reception strength among a plurality of acquired reception strengths are identical to each other, the warning output unit outputs the warning information on a basis of a result of a comparison between the reception strength of the signal having a second highest reception strength and a predetermined third threshold value used in outputting a proximity warning.

8. The work management device according to claim 6,
wherein the warning output unit outputs the warning information in a case where the read identifier and the identifier indicated by the received placement position identification signal are not identical to each other.

9. The work management device according to claim 7,
wherein the warning output unit outputs the warning information in a case where the read identifier and the identifier indicated by the signal having a second highest reception strength are not identical to each other.

10. The work management device according to claim 1,
wherein the warning information is information for warning that the transportation target and the cargo-handling machine are close to each other.

11. The work management device according to claim 4,
wherein the warning information is information for warning of a work error of transporting a transportation target having an identifier different from the identifier of the transportation target included in the work instruction information.

12. The work management device according to claim 8,
wherein the warning information is information for warning of a work error of a carry-in source or a carry-out destination having an identifier different from the identifier of the carry-in source or the carry-out destination included in the work instruction information.

13. A work management method comprising:
acquiring a reception strength of a transportation target identification signal transmitted from a first signal transmission device attached to a transportation target when the transportation target identification signal is received by a reading device attached to a cargo-handling machine; and
outputting warning information associated with work of the transportation target on a basis of a result of a comparison between the reception strength and a predetermined first threshold value used in outputting a proximity warning.

14. (canceled)

15. A cargo-handling machine comprising the work management device according to claim 1.
